(19) United States
(12) Patent Application Publication
(10) Pub. No.: US 2026/0319807 A1
(43) Pub. Date: Oct. 15, 2026

(54) EXPECTED-CONFIGURATION GENERATION DEVICE, INFORMATION PROCESSING METHOD, AND NON-TRANSITORY COMPUTER-READABLE STORAGE MEDIUM

(71) Applicant: NEC Corporation, Tokyo (JP)

(72) Inventors: Kotaro INOUE, Tokyo (JP); Tatsuya FUKUDA, Tokyo (JP); Takuya KUWAHARA, Tokyo (JP)

(73) Assignee: NEC Corporation, Tokyo (JP)

(21) Appl. No.: 19/466,690

(22) Filed: Feb. 2, 2026

(30) Foreign Application Priority Data
Mar. 6, 2025 (JP) 2025-035183

(51) Int. Cl. G06F 9/4401

(52) U.S. Cl. CPC G06F 9/4411

(57) ABSTRACT

First prompt information that includes a configuration document describing a component for operating a specific design target in a computer system, and an instruction document that instructs extraction of the component from the configuration document and extraction of a peripheral configuration of the component for operating the component normally is output to a large language model device. Expected-configuration information describing the component for operating the design target, the peripheral configuration, and a relationship between the component and the peripheral configuration is generated from basic architecture information including the component and the peripheral configuration included in a first analysis result output by the large language model device based on the first prompt information.

This application is based upon and claims the benefit of priority from Japanese Patent Application No. 2025-035183, filed on March 6, 2025, the disclosure of which is incorporated herein in its entirety by reference.

### TECHNICAL FIELD

The present disclosure relates to an expected-configuration generation device, an information processing method, and a program.

### BACKGROUND ART

Various techniques have been proposed for designing systems in information communication techniques and the like. For example, WO 2019/216082 A1 has proposed a method for automatically designing a system configuration that satisfies requirement information expressed as graph-like data.

### SUMMARY

An expected-configuration generation device according to an exemplary aspect of the present disclosure includes first prompt information output means for outputting, to a large language model device, first prompt information that includes a configuration document describing a component for operating a specific design target in a computer system, and an instruction document that instructs extraction of the component from the configuration document and extraction of a peripheral configuration of the component for operating the component normally, and expected-configuration information generation means for generating expected-configuration information describing the component for operating the design target, the peripheral configuration, and a relationship between the component and the peripheral configuration from basic architecture information including the component and the peripheral configuration included in a first analysis result output by the large language model device based on the first prompt information.

An information processing method according to an exemplary aspect of the present disclosure includes outputting, to a large language model device, first prompt information that includes a configuration document describing a component for operating a specific design target in a computer system, and an instruction document that instructs extraction of the component from the configuration document and extraction of a peripheral configuration of the component for operating the component normally, and generating expected-configuration information describing the component for operating the design target, the peripheral configuration, and a relationship between the component and the peripheral configuration from basic architecture information including the component and the peripheral configuration included in a first analysis result output by the large language model device based on the first prompt information.

A program according to an exemplary aspect of the present disclosure causes a computer of an expected-configuration generation device to function as first prompt information output means for outputting, to a large language model device, first prompt information that includes a configuration document describing a component for operating a specific design target in a computer system, and an instruction document that instructs extraction of the component from the configuration document and extraction of a peripheral configuration of the component for operating the component normally, and expected-configuration information generation means for generating expected-configuration information describing the component for operating the design target, the peripheral configuration, and a relationship between the component and the peripheral configuration from basic architecture information including the component and the peripheral configuration included in a first analysis result output by the large language model device based on the first prompt information.

### BRIEF DESCRIPTION OF THE DRAWINGS

FIG. 1 is a block diagram illustrating a configuration of an expected-configuration generation device according to an aspect of the present disclosure;

FIG. 2 is a diagram illustrating an example of a hardware configuration of an expected-configuration generation device according to an aspect of the present disclosure;

FIG. 3 is a flowchart illustrating a flow of a model data generation method according to an aspect of the present disclosure;

FIG. 4 is a block diagram illustrating a configuration of an expected-configuration generation device according to an aspect of the present disclosure;

FIG. 5A is a first diagram illustrating an example of configuration documents stored in an expected-configuration generation device according to an aspect of the present disclosure;

FIG. 5B is a second diagram illustrating an example of configuration documents stored in an expected-configuration generation device according to an aspect of the present disclosure;

FIG. 6 is a diagram illustrating an example of data format information stored in an expected-configuration generation device according to an aspect of the present disclosure;

FIG. 7 is a diagram illustrating an example of an expected configuration created by an expected-configuration generation device according to an aspect of the present disclosure;

FIG. 8 is a diagram illustrating a processing flow of an expected-configuration generation device according to an aspect of the present disclosure;

FIG. 9A is a third diagram illustrating an example of configuration documents stored in an expected-configuration generation device according to an aspect of the present disclosure;

FIG. 9B is a fourth diagram illustrating an example of configuration documents stored in an expected-configuration generation device according to an aspect of the present disclosure;

FIG. 10 is a diagram illustrating a display example according to an aspect of the present disclosure;

FIG. 11 is a functional block diagram of an expected-configuration generation device according to another aspect of the present disclosure; and

FIG. 12 is a diagram illustrating a processing flow of an expected-configuration generation device according to another aspect of the present disclosure.

### EXAMPLE EMBODIMENT

Hereinafter, example embodiments of the present disclosure will be described. However, the present disclosure is not limited to the following exemplary example embodiments, and various modifications can be made within a scope described in the claims. For example, example embodiments obtained by appropriately combining techniques (some or all of objects or methods) adopted in the following exemplary example embodiments can also be included in the scope of the present disclosure. Example embodiments obtained by appropriately omitting some of the techniques adopted in the following exemplary example embodiments can also be included in the scope of the present disclosure. Effects mentioned in the following exemplary example embodiments are examples of effects expected in the exemplary example embodiments, and do not define extension of the present disclosure. That is, example embodiments that do not provide the effects mentioned in each of the exemplary example embodiments described below can also be included in the scope of the present disclosure.

### First Exemplary Example Embodiment

A first exemplary example embodiment that is an example of the example embodiments of the present disclosure will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technical element illustrated in the drawings referred to for describing the present exemplary example embodiment can also be adopted in another exemplary example embodiment included in the present disclosure within a range in which no particular technical problem occurs.

### Configuration of Information Display Device

An expected-configuration generation device 10 generates expected-configuration information from configuration documents.

The configuration documents are documents such as a past system configuration example, a precondition and a configuration procedure in a system configuration, and the like, which serve as a reference source when creating an expected configuration. The expected configuration is data that formalizes peripheral configurations required for each element constituting a system to operate normally.

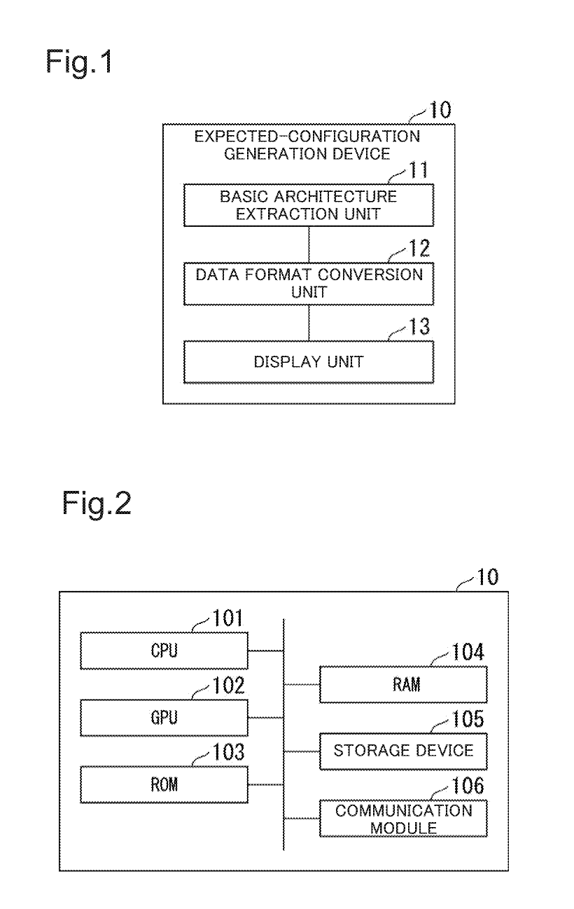

A configuration of the expected-configuration generation device 10 will be described with reference to FIG. 1. FIG. 1 is a functional block diagram illustrating the configuration of the expected-configuration generation device 10 according to an aspect of the present disclosure. As illustrated in FIG. 1, the expected-configuration generation device 10 includes a basic architecture extraction unit 11, a data format conversion unit 12, and a display unit 13.

FIG. 2 is a diagram illustrating an example of a hardware configuration of the expected-configuration generation device 10 according to an aspect of the present disclosure.

The expected-configuration generation device 10 is, as one example, a computer equipped with hardware such as a Central Processing Unit (CPU) 101, a Graphics Processing Unit (GPU) 102, a Read Only Memory (ROM) 103, a Random Access Memory (RAM) 104, a storage device 105 such as another Hard Disk Drive (HDD), and a communication module 106, as illustrated in FIG. 2. The arithmetic functions of the CPU 101 of the expected-configuration generation device 10 execute a program to implement functions of the basic architecture extraction unit 11, the data format conversion unit 12, and the display unit 13.

The basic architecture extraction unit 11 generates a basic architecture by extracting common information from multiple types of configuration documents. The basic architecture extraction unit 11 may be achieved by any device capable of extracting common information and outputting text, and examples thereof include a generative Artificial Intelligence (AI) using a large language model device.

The data format conversion unit 12 converts the basic architecture into a format of an expected configuration.

The display unit 13 displays the expected-configuration information after the conversion. The display unit 13 may be achieved by any device capable of displaying information, and examples thereof include a liquid crystal display or an organic Electro Luminescence (EL) display.

### Flow of Information Display Method

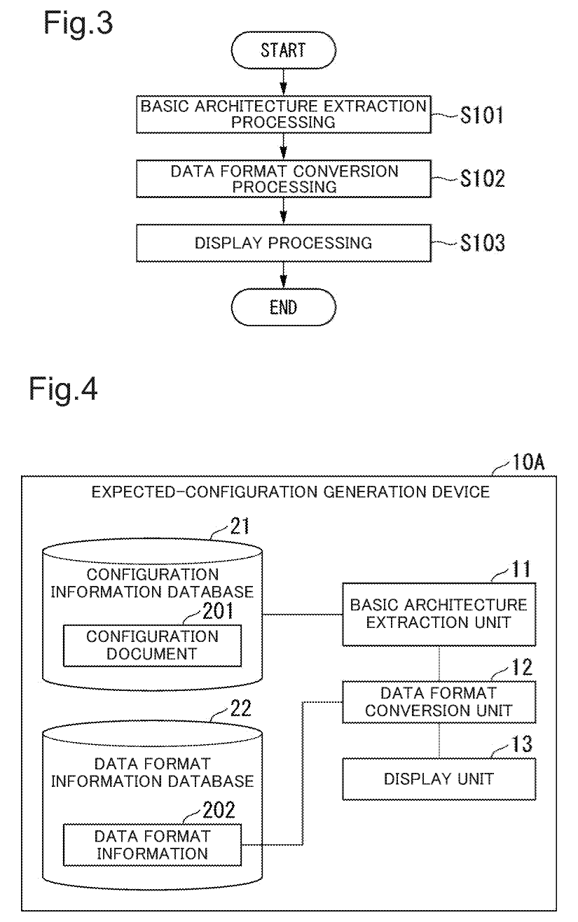

A flow of a model data generation method will be described with reference to FIG. 3. FIG. 3 is a flowchart illustrating the flow of the model data generation method. As illustrated in FIG. 3, the model data generation method executed by the expected-configuration generation device 10 includes basic architecture extraction processing S101, data format conversion processing S102, and display processing S103.

In the basic architecture extraction processing S101, a basic architecture is generated by extracting common information from multiple types of configuration documents.

In the data format conversion processing S102, the basic architecture is converted into a format of an expected configuration.

In the display processing S103, the expected-configuration information after the conversion is displayed.

### Effects of Information Display Method

As described above, in the model data generation method, a method of generating expected-configuration information by extracting information from configuration documents is adopted. Therefore, with the model data generation method, a user can generate expected-configuration information that does not include circumstances unique to a specific product, based on the configuration documents. As a result, it is possible to obtain an effect that the user can utilize an automatic design technique without requiring advanced expertise or high cost.

### Second Exemplary Example Embodiment

A second exemplary example embodiment that is an example of the example embodiments of the present disclosure will be described in detail with reference to the drawings. Components having the same functions as the components described in the above-described exemplary example embodiment are denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Furthermore, each technique illustrated in the drawings referred to for describing the present exemplary example embodiment may also be adopted in another exemplary example embodiment included in the present disclosure within a range in which no particular technical problem occurs.

### Configuration of Information Display Device

A configuration of an expected-configuration generation device 10A will be described with reference to FIG. 4. FIG. 4 is a functional block diagram illustrating the configuration of the expected-configuration generation device 10A. As illustrated in FIG. 4, the expected-configuration generation device 10A includes, in addition to the basic architecture extraction unit 11 the data format conversion unit 12, and the display unit 13 that are provided in the expected-configuration generation device 10, a configuration information database 21 and a data format information database 22.

A configuration document 201 is information describing a past system configuration example, a precondition and a configuration procedure in a system configuration. Examples of the former include a basic design document and a detailed design document of a system. Examples of the latter include a product manual.

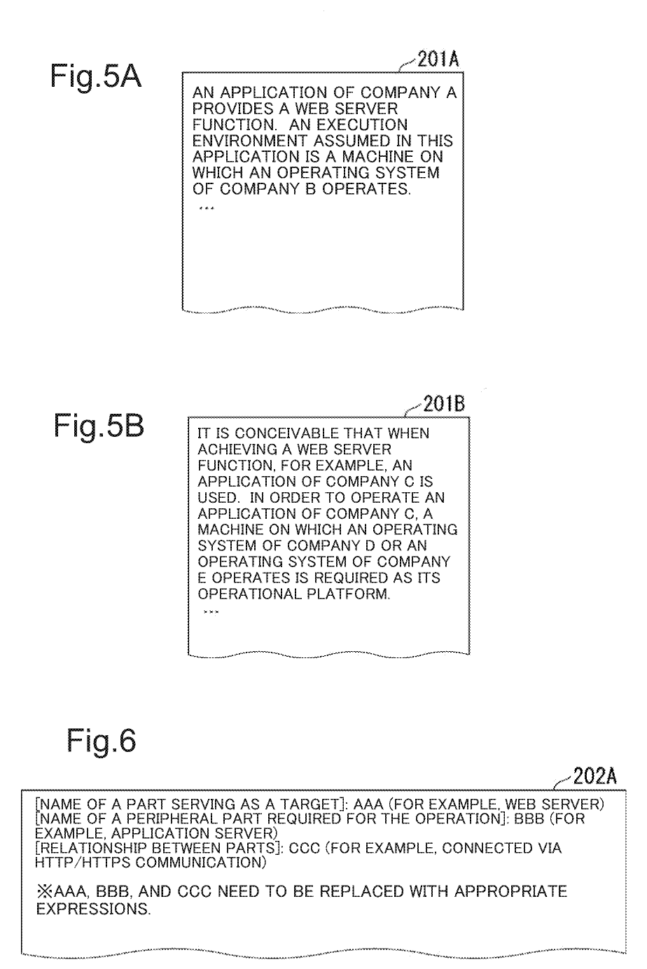

FIG. 5A and FIG. 5B illustrate examples of the configuration document 201 according to an aspect of the present disclosure. A configuration document 201A illustrated in FIG. 5A is a document describing an operating environment for an application of Company A developed by Company A. The configuration document 201A indicates that, for the application of Company A to operate, an operating system of Company B is required as an execution environment. A configuration document 201B illustrated in FIG. 5B is a document describing an operating environment for an application developed by Company C. The configuration document 201B indicates that, for the application of Company C to operate, an operating system of Company D or an operating system of Company E is required as an execution environment.

The expected-configuration generation device 10 generates first prompt information, which includes a configuration document describing a component for operating a specific design target in a computer system, and an instruction document that instructs extraction of the component from the configuration document and extraction of a peripheral configuration of the component for operating the component normally. The expected-configuration generation device 10 outputs the first prompt information to a large language model device (LLM). The expected-configuration generation device 10 generates expected-configuration information that describes a common component for operating the design target, a peripheral configuration for operating the component, and a relationship between the component and the peripheral configuration, from basic architecture information including the components and the peripheral configurations included in a first analysis result output by the LLM based on the first prompt information. In this processing, the expected-configuration generation device 10 outputs, to a large language model device, the first prompt information including configuration documents of multiple products (for example, specific types of applications provided by Company A and Company B) associated with a specific design target (application), such as the configuration documents 201A in FIG. 5A and 201B in FIG. 5B, and an instruction document that instructs extraction of components and extraction of peripheral configurations of the components for operating the components normally, from the multiple configuration documents.

FIG. 6 illustrates an example of data format information according to an aspect of the present disclosure. Data format information 202A illustrated in FIG. 6 is information indicating a definition of a predetermined format used to output, in the predetermined format, a component for operating the design target, a peripheral configuration of the component, and a relationship between the component and the peripheral configuration, based on a sentence including the component and the peripheral configuration included in the analysis result output by the large language model device. The expected-configuration generation device 10A outputs, by using this data format information, the expected-configuration information that describes, in a predetermined format, a component for operating the design target, a peripheral configuration of the component, and a relationship between the component and the peripheral configuration, based on the sentence including the component and the peripheral configuration included in the analysis result output by the large language model device. The expected-configuration information is presented in a format divided into three items: name of a part serving as a target (component), name of a peripheral part required for operating a component (peripheral configuration), and relationship between the parts (the component and the peripheral configuration).

For example, in a case where an application program is the design target, and an expected configuration such as “a web server is connected to an application server via HTTP/HTTPS communication” is expressed in accordance with this data format information, the item name of a part serving as a target (component) includes a word “web server”, the item name of a peripheral part required for operating a component (peripheral configuration) includes a word “application server”, and the item relationship between the parts (the component and the peripheral configuration) includes a sentence “connected via HTTP/HTTPS communication”, respectively.

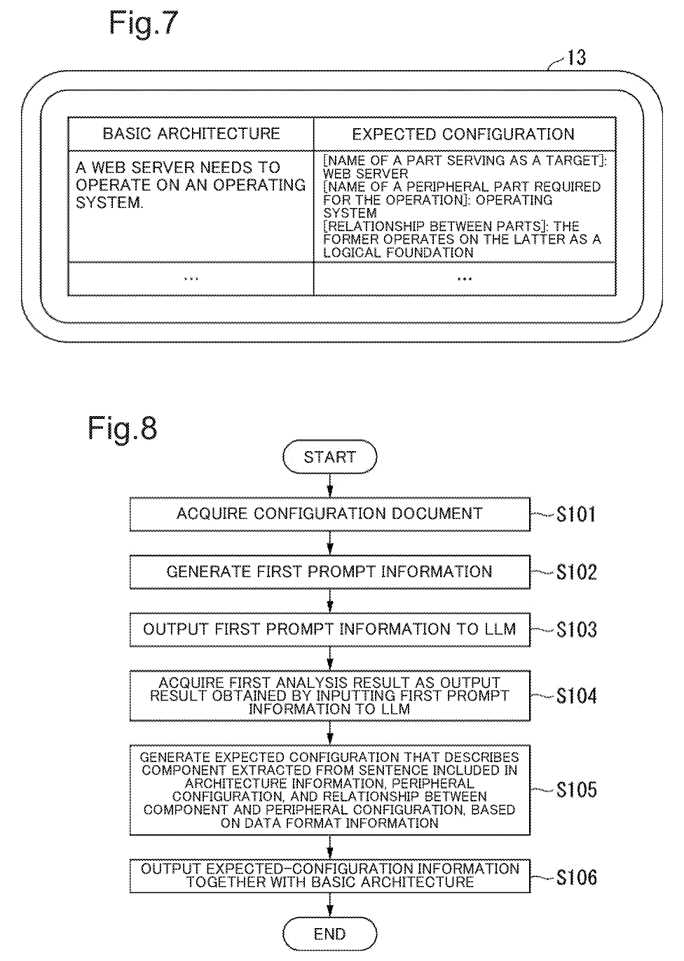

FIG. 7 is a diagram illustrating an example of expected-configuration information according to an aspect of the present disclosure.

FIG. 8 is a diagram illustrating a processing flow of the expected-configuration generation device according to an aspect of the present disclosure.

Here, with reference to FIGS. 4 to 7, an example of a procedure for generating expected-configuration information in the expected-configuration generation device 10A will be described. First, the basic architecture extraction unit 11 acquires the configuration documents 201A (a configuration document of a specific type of application a provided by Company A) and 201B (a configuration document of a specific type of application b provided by Company C) from the configuration information database 21 (step S101). The application a and the application b are specific types of applications provided by different companies, and as an example, Apache (registered trademark) and Nginx (registered trademark), which are used as web server software, correspond to the application a and the application b. The configuration document 201A may be a document created by an administrator or the like who previously constructed the system, or may be a document recorded on the Internet. The configuration documents 201A and 201B are collectively referred to as the configuration document 201.

The basic architecture extraction unit 11 generates first prompt information including the multiple acquired configuration documents 201 and the instruction document that instructs extraction of common components from the multiple configuration documents 201 and extraction of peripheral configurations for operating the components normally (step S102). The instruction document may be a template sentence created in advance by an administrator or the like of the expected-configuration generation device 10A. The basic architecture extraction unit 11 outputs the first prompt information to the LLM (step S103). The LLM outputs a first analysis result, which is a result obtained by inputting the first prompt information. The basic architecture extraction unit 11 acquires the first analysis result (step S104). Note that the basic architecture extraction unit 11 may perform the functions of the LLM.

The first analysis result is a sentence that describes general components for operating the analysis target and peripheral configurations thereof, which are extracted by the LLM from the multiple configuration documents 201 based on the prompt information. As one example, in a case where the analysis target is an application, the first analysis result is a sentence describing the component (web server) for operating the application and the peripheral configuration (application server) for operating the component.

This sentence is referred to as a basic architecture.

According to the processing performed by the expected-configuration generation device 10A described above, the basic architecture extraction unit 11 can extract, from each acquired configuration document, components that are regarded as components of the system serving as the design target. Here, for example, the application (component) of Company A, the operating system (component) of Company B, and the like are extracted from the configuration document 201A, and the application (component) of Company C, the operating system (component) of Company D, and the like are extracted from the configuration document 201B. The basic architecture extraction unit 11 can extract, for each extracted component, information on the peripheral configurations required for the component to operate normally, based on the analysis results of the LLM. For example, information “the application of Company A needs to operate on the operating system of Company B in order to operate” is extracted from the configuration document 201A, and information “the application of Company C needs to operate on the operating system of Company D or the operating system of Company E in order to operate” is extracted from the configuration document 201B.

In addition, according to the processing performed by the basic architecture extraction unit 11 described above, the extracted components can be classified into more abstract groups based on the processing of the LLM using the first prompt information. For example, the application of Company A and the application of Company C are both classified into a more abstract group called a web server. The operating system of Company B, the operating system of Company D, and the operating system of Company E are all classified into a more abstract group called an operating system. According to the processing performed by the basic architecture extraction unit 11 described above, regarding information on the peripheral configurations required for each component to operate normally, it is possible to generate the information in which the components included therein are replaced with the names of more abstract groups, based on the processing of the LLM using the first prompt information. Here, for example, from the information “the application of Company A needs to operate on the operating system of Company B in order to operate” and the information “the application of Company C needs to operate on the operating system of Company D or the operating system of Company E in order to operate”, information (basic architecture information) converted into a form “a web server needs to operate on an operating system” is generated by the LLM in both cases. Finally, in a case where similar information is generated as a result of the conversion using abstract group names, that information is determined to be the basic architecture information. Here, for example, since the information “a web server needs to operate on an operating system” appears multiple times as a result of the conversion using abstract group names, that information is determined to be the basic architecture information. In the processing described above, the basic architecture extraction unit 11 generates prompt information for causing the LLM to generate such basic architecture information, and outputs the prompt information to the LLM. In a case where the basic architecture extraction unit 11 has functions of the LLM, the basic architecture extraction unit 11 may similarly generate the basic architecture information.

The basic architecture extraction unit 11 outputs, to the data format conversion unit 12, architecture information as a sentence that is included in the first analysis result and indicates the component as the analysis target and peripheral configurations thereof. The data format conversion unit 12 acquires the architecture information. The data format conversion unit 12 acquires the data format information 202A (FIG. 6) from the data format information database 22. The data format conversion unit 12 generates an expected configuration that describes the component extracted from the sentence included in the architecture information, the peripheral configuration, and the relationship between the component and the peripheral configuration, based on the data format information (step S105).

More specifically, the data format conversion unit 12 specifies, using the acquired data format information 202A, portions among pieces of the information such as the component and the peripheral configuration included in the architecture information that need to be replaced during the conversion. Here, the data format conversion unit 12 specifies that replacement is required for the values of three items name of a part serving as a target, name of a peripheral part required for the operation, and relationship between the parts. The data format conversion unit 12 generates expected-configuration information by extracting, from the basic architecture acquired from the basic architecture extraction unit 11, information necessary for performing the above three replacements and then performing the replacements. Here, for example, from the basic architecture “a web server needs to operate on an operating system”, by extracting “web server” as a value to be input for the item name of a part serving as a target, “operating system” as a value to be input for the item name of a peripheral part required for the operation, and “the former operates on the latter as a logical foundation” as a value to be input for the item relationship between the parts, the expected-configuration information is generated.

The data format conversion unit 12 may generate the expected-configuration information by using the LLM. For example, the data format conversion unit 12 generates second prompt information including a basic architecture, format definition information, and an instruction document. Instruction information is the instruction document that instructs generation, from the basic architecture information, of expected-configuration information that describes, in a predetermined format, a component for operating the design target, a peripheral configuration, and a relationship between the component and the peripheral configuration. The data format conversion unit 12 outputs the second prompt information to the LLM. The LLM generates expected-configuration information using the second prompt information. In a case where the data format conversion unit 12 has functions of the LLM, the data format conversion unit 12 may similarly generate the expected-configuration information by using the LLM.

The data format conversion unit 12 outputs the generated expected-configuration information, together with the basic architecture, to the display unit 13 (step S106).

The display unit 13 displays the basic architecture and the expected configuration (FIG. 7) output from the data format conversion unit 12, on a predetermined output destination such as a terminal or a display.

### Effects of Information Display Device

As described above, the expected-configuration generation device 10A adopts a configuration of generating expected-configuration information by extracting information from the configuration documents. Therefore, with the expected-configuration generation device 10A, it is possible to generate expected-configuration information that does not include circumstances unique to a specific product, based on the configuration documents. As a result, it is possible to obtain an effect that the user can utilize an automatic design technique without requiring advanced expertise or high cost.

### Third Exemplary Example Embodiment

A third exemplary example embodiment that is an example of the example embodiments of the present disclosure will be described in detail with reference to the drawings. Components having the same functions as the components described in the above-described exemplary example embodiment are denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Furthermore, each technique illustrated in the drawings referred to for describing the present exemplary example embodiment may also be adopted in another exemplary example embodiment included in the present disclosure within a range in which no particular technical problem occurs.

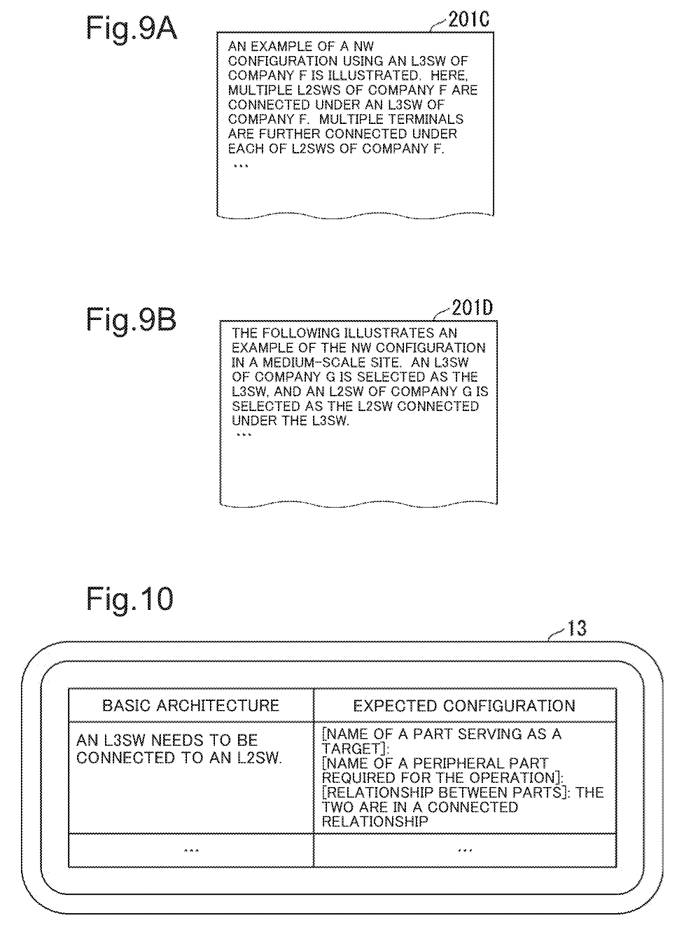

FIG. 9A is a third diagram illustrating examples of the configuration documents according to an aspect of the present disclosure. FIG. 9B is a fourth diagram illustrating examples of the configuration documents according to an aspect of the present disclosure. A configuration document 201C illustrated in FIG. 9A is a document describing an operating environment for a Layer 3 switch (L3SW) developed by Company F. The configuration document 201C indicates that the L3SW of Company F operates in a manner connected to a Layer 2 switch (L2SW) of Company F. A configuration document 201D illustrated in FIG. 9B is a document describing an operating environment for an L3SW developed by Company G. The configuration document 201D indicates that the L3SW of Company G operates in a manner connected to an L2SW of Company G.

Next, processing in the expected-configuration generation device according to the third exemplary example embodiment will be described in the same manner.

First, the basic architecture extraction unit 11 acquires the configuration documents 201C and 201D from the configuration information database 21. The configuration documents 201C and 201D may be documents created by an administrator who previously constructed the system, or may be information recorded on the Internet. The configuration documents 201C and 201D are collectively referred to as the configuration document 201. The basic architecture extraction unit 11 extracts, as a basic architecture, information common to the information included in the acquired configuration document 201.

The basic architecture extraction unit 11 generates first prompt information including the multiple acquired configuration documents 201 and the instruction document that instructs extraction of common components from the multiple configuration documents 201 and extraction of peripheral configurations for operating the components normally (step S102). The instruction document may be a template sentence created in advance by an administrator or the like of the expected-configuration generation device 10A. The basic architecture extraction unit 11 outputs the first prompt information to the LLM (step S103). The LLM outputs a first analysis result, which is a result obtained by inputting the first prompt information. The basic architecture extraction unit 11 acquires the first analysis result (step S104). Note that the basic architecture extraction unit 11 may perform the functions of the LLM.

According to the processing performed by the expected-configuration generation device 10A described above, the basic architecture extraction unit 11 can extract, from each acquired configuration document 201, components that are regarded as components of the system serving as the design target. Here, for example, the L3SW of Company F, the L2SW of Company F, and the like are extracted from the configuration document 201C, and the L3SW of Company G, the L2SW of Company G, and the like are extracted from the configuration document 201D. The basic architecture extraction unit 11 can extract, for each extracted component, information on the peripheral configurations required for the component to operate normally, based on the analysis results of the LLM. Here, for example, information “the L3SW of Company F needs to operate in a manner connected to the L2SW of Company F” is extracted from the configuration document 201C, and information “the L3SW of Company G needs to operate in a manner connected to the L2SW of Company G” is extracted from the configuration document 201D.

In addition, according to the processing performed by the basic architecture extraction unit 11 described above, the extracted components can be classified into more abstract groups based on the processing of the LLM using the first prompt information. Here, for example, the L3SW of Company F and the L3SW of Company G are both classified into a more abstract group called an L3SW. The L2SW of Company F and the L2SW of Company G are both classified into a more abstract group called an L2SW. According to the processing performed by the basic architecture extraction unit 11 described above, regarding information on the peripheral configurations required for each component to operate normally, the information in which the components included therein are replaced with the names of more abstract groups is generated, based on the processing of the LLM using the first prompt information. Here, for example, from the information “the L3SW of Company F needs to operate in a manner connected to the L2SW of Company F” and the information “the L3SW of Company G needs to operate in a manner connected to the L2SW of Company G”, information converted into a form “an L3SW needs to operate in a manner connected to an L2SW” is generated in both cases. Finally, in a case where similar information is generated as a result of the conversion using abstract group names, that information is determined to be the basic architecture. Here, for example, since the information “an L3SW needs to operate in a manner connected to an L2SW” appears multiple times as a result of the conversion using abstract group names, that information is determined to be the basic architecture. In the processing described above, the basic architecture extraction unit 11 generates prompt information for causing the LLM to generate such basic architecture information, and outputs the prompt information to the LLM. In a case where the basic architecture extraction unit 11 has functions of the LLM, the basic architecture extraction unit 11 may similarly generate the basic architecture information.

The basic architecture extraction unit 11 outputs, to the data format conversion unit 12, architecture information as a sentence that is included in the first analysis result and indicates the component as the analysis target and peripheral configurations thereof. The data format conversion unit 12 acquires the architecture information. The data format conversion unit 12 acquires the data format information 202A (FIG. 6) from the data format information database 22. The data format conversion unit 12 generates an expected configuration that describes the component extracted from the sentence included in the architecture information, the peripheral configuration, and the relationship between the component and the peripheral configuration, based on the data format information (step S105).

More specifically, the data format conversion unit 12 specifies, using the acquired data format information 202A, portions among pieces of the information such as the component and the peripheral configuration included in the architecture information that need to be replaced during the conversion. Here, the data format conversion unit 12 specifies that replacement is required for the values of three items name of a part serving as a target, name of a peripheral part required for the operation, and relationship between the parts. The data format conversion unit 12 generates expected-configuration information by extracting, from the basic architecture acquired from the basic architecture extraction unit 11, information necessary for performing the above three replacements and then performing the replacements. Here, for example, from the basic architecture “a web server needs to operate on an operating system”, by extracting “L3SW” as a value to be input for the item [name of a part serving as a target, “L2SW” as a value to be input for the item name of a peripheral part required for the operation, and “the two are in a connected relationship” as a value to be input for the item relationship between the parts, the expected-configuration information is generated.

The data format conversion unit 12 may generate the expected-configuration information by using the LLM. For example, the data format conversion unit 12 generates second prompt information including a basic architecture, format definition information, and an instruction document. Instruction information is the instruction document that instructs generation, from the basic architecture information, of expected-configuration information that describes, in a predetermined format, a component for operating the design target, a peripheral configuration, and a relationship between the component and the peripheral configuration. The data format conversion unit 12 outputs the second prompt information to the LLM. The LLM generates expected-configuration information using the second prompt information. In a case where the data format conversion unit 12 has functions of the LLM, the data format conversion unit 12 may similarly generate the expected-configuration information by using the LLM.

The data format conversion unit 12 outputs the generated expected-configuration information, together with the basic architecture, to the display unit 13 (step S106).

FIG. 10 is a diagram illustrating a display example according to an aspect of the present disclosure.

The display unit 13 displays the basic architecture and the expected configuration output from the data format conversion unit 12, on a predetermined output destination such as a terminal or a display.

### Effects of Information Display Device

As described above, the expected-configuration generation device 10A adopts a configuration of generating expected-configuration information by extracting information from the configuration documents. Therefore, with the expected-configuration generation device 10A, it is possible to generate expected-configuration information that does not include circumstances unique to a specific product, based on the configuration documents. As a result, it is possible to obtain an effect that the user can utilize an automatic design technique without requiring advanced expertise or high cost.

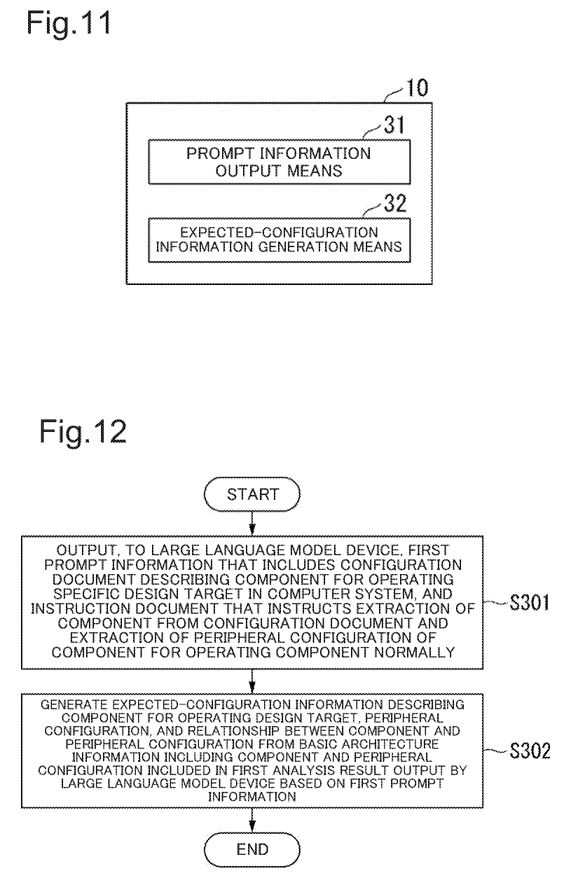

FIG. 11 is a functional block diagram of an expected-configuration generation device according to another aspect of the present disclosure.

FIG. 12 is a diagram illustrating a processing flow of an expected-configuration generation device according to another aspect of the present disclosure.

The expected-configuration generation device 10 exhibits at least the functions of prompt information output means 31 and expected-configuration information generation means 32.

The prompt information output means 31 outputs, to the large language model device, first prompt information that includes a configuration document describing a component for operating a specific design target in a computer system, and an instruction document that instructs extraction of the component from the configuration document and extraction of a peripheral configuration of the component for operating the component normally (step S301).

The expected-configuration information generation means 32 generates expected-configuration information that describes a component for operating the design target, a peripheral configuration, and a relationship between the component and the peripheral configuration, from basic architecture information including the components and the peripheral configurations included in a first analysis result output by the large language model device based on the first prompt information (step S302).

In a system design device disclosed in WO 2019/216082 A1, requirement information for a system requested by a user is received as input, and, for each component (a server, an NW switch, a web application, or the like) included in the requirement information, a design proposal that materializes the requirement information is generated based on data (hereinafter referred to as “expected configuration”) in which peripheral configurations required for the component to operate normally are formalized.

In order to achieve the operation of such a system design device, it is necessary to have prior knowledge, for each component that may be included in the requirement information serving as input, of information on the expected configuration required for the component to operate.

Here, the components include a concrete component that represents a specific product (such as Apache (registered trademark) HTTP Server, Nginx (registered trademark), or Internet Information Services (IIS (registered trademark))) and an abstract component (such as a web server, an application server, or a database server) that generalizes a product group of a certain type. For the latter (abstract components), it is expected that information on a generic expected configuration (for example, a product group generally classified as a web server operates on an operating system) that does not assume any specific product will be presented as a design proposal.

A document (hereinafter, referred to as a “configuration document”), which describes a past system configuration example or a precondition (for example, a specific middleware is required as an expected configuration for an application server to operate) in a system configuration and is a reference source when a person creates an expected configuration, may include a description that assumes a specific product (such as Apache (registered trademark) HTTP Server, Nginx (registered trademark), or IIS (registered trademark)).

In a case where an expected configuration is created with reference only to a specific configuration document, the expected configuration may include circumstances unique to the specific product assumed in the document, and thus there is a problem that a generic expected configuration is not obtained.

An object of the present disclosure is to provide an expected-configuration generation device, an information processing method, and a program that resolve the above-described problems.

According to an exemplary aspect of the present disclosure, it is possible to generate expected-configuration information indicating a component for operating a specific design target in a computer system, a peripheral configuration of the component, and a relationship between the component and the peripheral configuration by using a configuration document in which the component is described.

### Example of Achievement by Software

Some or all of the functions of the expected-configuration generation devices 10 and 10A (hereinafter, also referred to as “each of the above devices”) may be achieved by hardware such as an integrated circuit (IC chip) or may be achieved by software.

In the latter case, each of the above devices is achieved by, for example, a computer that executes commands of a program that is software for achieving each function. FIG. 2 is an example of such a computer.

The computer includes at least one processor and at least one memory. A program for causing the computer to operate as each of the above devices is recorded in the memory. In the computer, the processor reads the program from the memory and executes the program to achieve each function of each of the above devices.

Examples of the processor include, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, and a combination thereof.

Examples of the memory include a flash memory, a Hard Disk Drive (HDD), a Solid State Drive (SSD), and a combination thereof.

The computer may further include a Random Access Memory (RAM) for loading the program at the time of execution and temporarily storing various kinds of data. The computer may further include a communication interface for transmitting and receiving data to and from another device. The computer may further include an input/output interface for connecting input/output equipment such as a keyboard, a mouse, a display, and a printer.

The program can be recorded on a non-transitory tangible recording medium readable by the computer. As such a recording medium, for example, a tape, a disk, a card, a semiconductor memory, a programmable logic circuit, or the like can be used. The computer can acquire the program via such a recording medium. The program can be transmitted via a transmission medium. As such a transmission medium, for example, a communication network, a broadcast wave, or the like can be used. The computer can also acquire the program via such a transmission medium.

Each of the above functions of each of the above devices may be achieved by a single processor provided in a single computer, may be achieved in cooperation with a plurality of processors provided in a single computer, or may be achieved in cooperation with a plurality of processors provided in each of a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in each of a plurality of computers.

While the present disclosure has been described with reference to the example embodiments, the present disclosure is not limited to these example embodiments. It will be understood by those of ordinary skill in the art that various changes in form and details may be made therein without departing from the spirit and scope of the present disclosure as defined by the claims.

Some or all of the above-described example embodiments may be described as the following supplementary notes, but are not limited thereto.

### Supplementary Note 1

An expected-configuration generation device including:
first prompt information output means for outputting, to a large language model device, first prompt information that includes a configuration document describing a component for operating a specific design target in a computer system, and an instruction document that instructs extraction of the component from the configuration document and extraction of a peripheral configuration of the component for operating the component normally; and
expected-configuration information generation means for generating expected-configuration information describing the component for operating the design target, the peripheral configuration, and a relationship between the component and the peripheral configuration from basic architecture information including the component and the peripheral configuration included in a first analysis result output by the large language model device based on the first prompt information.

### Supplementary Note 2

The expected-configuration generation device according to Supplementary Note 1, in which
the first prompt information output means outputs, to the large language model device, first prompt information including configuration documents of a plurality of products associated with the specific design target, and an instruction document that instructs extraction of the component from the configuration documents of the plurality of products and extraction of a peripheral configuration of the component for operating the component normally.

### Supplementary Note 3

The expected-configuration generation device according to Supplementary Note 2, in which
the basic architecture information includes the component common to the configuration documents of the plurality of products.

### Supplementary Note 4

The expected-configuration generation device according to any one of Supplementary Notes 1 to 3, in which
the expected-configuration information generation means generates expected-configuration information describing, in a predetermined format, a component for operating the design target, a peripheral configuration, and a relationship between the component and the peripheral configuration from the basic architecture information by using the basic architecture information including the component and the peripheral configuration included in the first analysis result output by the large language model device based on the first prompt information, and format definition information that defines the predetermined format of the expected-configuration information.

### Supplementary Note 5

The expected-configuration generation device according to Supplementary Note 4, further including:
second prompt information output means for outputting, to the large language model device, second prompt information that includes the basic architecture information, the format definition information, and an instruction document that instructs generation of expected-configuration information describing, in the predetermined format, the component for operating the design target, the peripheral configuration, and the relationship between the component and the peripheral configuration from the basic architecture information, in which
the expected-configuration information generation means acquires the expected-configuration information included in a second analysis result output by the large language model device based on the second prompt information.

### Supplementary Note 6

The expected-configuration generation device according to any one of Supplementary Notes 1 to 5, in which
the design target is a predetermined application program, the component is a component required for an operation of the application program, and
the peripheral configuration is a peripheral configuration required for an operation of the component.

### Supplementary Note 7

The expected-configuration generation device according to any one of Supplementary Notes 1 to 5, in which
the design target is a predetermined network device,
the component is a component required for an operation of the network device, and
the peripheral configuration is a peripheral configuration required for an operation of the component.

### Supplementary Note 8

The expected-configuration generation device according to any one of Supplementary Notes 1 to 7, further including:
output means for outputting the expected-configuration information.

### Supplementary Note 9

An information processing method including:
outputting, to a large language model device, first prompt information that includes a configuration document describing a component for operating a specific design target in a computer system, and an instruction document that instructs extraction of the component from the configuration document and extraction of a peripheral configuration of the component for operating the component normally; and
generating expected-configuration information describing the component for operating the design target, the peripheral configuration, and a relationship between the component and the peripheral configuration from basic architecture information including the component and the peripheral configuration included in a first analysis result output by the large language model device based on the first prompt information.

### Supplementary Note10

The information processing method according to Supplementary Note 9, further including:
outputting, to the large language model device, first prompt information including configuration documents of a plurality of products associated with the specific design target, and an instruction document that instructs extraction of the component from the configuration documents of the plurality of products and extraction of a peripheral configuration of the component for operating the component normally.

### Supplementary Note 11

The information processing method according to Supplementary Note 10, in which
the basic architecture information includes the component common to the configuration documents of the plurality of products.

### Supplementary Note 12

The information processing method according to any one of Supplementary Notes 9 to 11, further including:
generating expected-configuration information describing, in a predetermined format, a component for operating the design target, a peripheral configuration, and a relationship between the component and the peripheral configuration from the basic architecture information by using the basic architecture information including the component and the peripheral configuration included in the first analysis result output by the large language model device based on the first prompt information, and format definition information that defines the predetermined format of the expected-configuration information.

### Supplementary Note 13

The information processing method according to Supplementary Note 12, further including:
outputting, to the large language model device, second prompt information that includes the basic architecture information, the format definition information, and an instruction document that instructs generation of expected-configuration information describing, in the predetermined format, the component for operating the design target, the peripheral configuration, and the relationship between the component and the peripheral configuration from the basic architecture information; and
acquiring the expected-configuration information included in a second analysis result output by the large language model device based on the second prompt information.

### Supplementary Note 14

The information processing method according to any one of Supplementary Notes 9 to 13, in which
the design target is a predetermined application program,
the component is a component required for an operation of the application program, and
the peripheral configuration is a peripheral configuration required for an operation of the component.

### Supplementary Note 15

The information processing method according to any one of Supplementary Notes 9 to 13, in which
the design target is a predetermined network device,
the component is a component required for an operation of the network device, and
the peripheral configuration is a peripheral configuration required for an operation of the component.

### Supplementary Note 16

The information processing method according to any one of Supplementary Notes 9 to 15, further including:
outputting the expected-configuration information.

### Supplementary Note 17

A program causing a computer of an expected-configuration generation device to function as:
first prompt information output means for outputting, to a large language model device, first prompt information that includes a configuration document describing a component for operating a specific design target in a computer system, and an instruction document that instructs extraction of the component from the configuration document and extraction of a peripheral configuration of the component for operating the component normally; and
expected-configuration information generation means for generating expected-configuration information describing the component for operating the design target, the peripheral configuration, and a relationship between the component and the peripheral configuration from basic architecture information including the component and the peripheral configuration included in a first analysis result output by the large language model device based on the first prompt information.

### Supplementary Note 18

The program according to Supplementary Note 17, in which
the first prompt information output means outputs, to the large language model device, first prompt information including configuration documents of a plurality of products associated with the specific design target, and an instruction document that instructs extraction of the component from the configuration documents of the plurality of products and extraction of a peripheral configuration of the component for operating the component normally.

### Supplementary Note 19

The program according to Supplementary Note 18, in which
the basic architecture information includes the component common to the configuration documents of the plurality of products.

### Supplementary Note 20

The program according to any one of Supplementary Notes 17 to 19, in which
the expected-configuration information generation means generates expected-configuration information describing, in a predetermined format, a component for operating the design target, a peripheral configuration, and a relationship between the component and the peripheral configuration from the basic architecture information by using the basic architecture information including the component and the peripheral configuration included in the first analysis result output by the large language model device based on the first prompt information, and format definition information that defines the predetermined format of the expected-configuration information.

### Supplementary Note 21

The program according to Supplementary Note 20 causing the computer to further function as:
second prompt information output means for outputting, to the large language model device, second prompt information that includes the basic architecture information, the format definition information, and an instruction document that instructs generation of expected-configuration information describing, in the predetermined format, the component for operating the design target, the peripheral configuration, and the relationship between the component and the peripheral configuration from the basic architecture information, in which
the expected-configuration information generation means acquires the expected-configuration information included in a second analysis result output by the large language model device based on the second prompt information.

### Supplementary Note 22

The program according to any one of Supplementary Notes 17 to 21, in which
the design target is a predetermined application program,
the component is a component required for an operation of the application program, and
the peripheral configuration is a peripheral configuration required for an operation of the component.

### Supplementary Note 23

The program according to any one of Supplementary Notes 17 to 22, in which
the design target is a predetermined network device,
the component is a component required for an operation of the network device, and
the peripheral configuration is a peripheral configuration required for an operation of the component.

### Supplementary Note 24

The program according to any one of Supplementary Notes 17 to 23 causing the computer to further function as:
output means for outputting the expected-configuration information.

1. An expected-configuration generation device comprising:
a memory; and
at least one processor coupled to the memory,
the at least one processor performing operations to:
output, to a large language model device, first prompt information that includes a configuration document describing a component for operating a specific design target in a computer system, and an instruction document that instructs extraction of the component from the configuration document and extraction of a peripheral configuration of the component for operating the component normally; and
generate expected-configuration information describing the component for operating the design target, the peripheral configuration, and a relationship between the component and the peripheral configuration from basic architecture information including the component and the peripheral configuration included in a first analysis result output by the large language model device based on the first prompt information.

2. The expected-configuration generation device according to claim 1, wherein
the at least one processor performing operations to:
output, to the large language model device, first prompt information including configuration documents of a plurality of products associated with the specific design target, and an instruction document that instructs extraction of the component from the configuration documents of the plurality of products and extraction of a peripheral configuration of the component for operating the component normally.

3. The expected-configuration generation device according to claim 2, wherein
the basic architecture information includes the component common to the configuration documents of the plurality of products.

4. The expected-configuration generation device according to claim 1, wherein
the at least one processor performing operations to:
generate expected-configuration information describing, in a predetermined format, a component for operating the design target, a peripheral configuration, and a relationship between the component and the peripheral configuration from the basic architecture information by using the basic architecture information including the component and the peripheral configuration included in the first analysis result output by the large language model device based on the first prompt information, and format definition information that defines the predetermined format of the expected-configuration information.

5. The expected-configuration generation device according to claim 4, wherein
the at least one processor performing operations to:
output, to the large language model device, second prompt information that includes the basic architecture information, the format definition information, and an instruction document that instructs generation of expected-configuration information describing, in the predetermined format, the component for operating the design target, the peripheral configuration, and the relationship between the component and the peripheral configuration from the basic architecture information, and
acquire the expected-configuration information included in a second analysis result output by the large language model device based on the second prompt information.

6. The expected-configuration generation device according to claim 5, wherein
the design target is a predetermined application program,
the component is a component required for an operation of the application program, and
the peripheral configuration is a peripheral configuration required for an operation of the component.

7. The expected-configuration generation device according to claim 5, wherein
the design target is a predetermined network device,
the component is a component required for an operation of the network device, and
the peripheral configuration is a peripheral configuration required for an operation of the component.

8. The expected-configuration generation device according to claim 1, wherein
the at least one processor performing operations to:
output the expected-configuration information.

9. An information processing method comprising:
outputting, to a large language model device, first prompt information that includes a configuration document describing a component for operating a specific design target in a computer system, and an instruction document that instructs extraction of the component from the configuration document and extraction of a peripheral configuration of the component for operating the component normally; and
generating expected-configuration information describing the component for operating the design target, the peripheral configuration, and a relationship between the component and the peripheral configuration from basic architecture information including the component and the peripheral configuration included in a first analysis result output by the large language model device based on the first prompt information.

10. A non-transitory computer-readable storage medium storing a program causing a computer to execute a process comprising:
outputting, to a large language model device, first prompt information that includes a configuration document describing a component for operating a specific design target in a computer system, and an instruction document that instructs extraction of the component from the configuration document and extraction of a peripheral configuration of the component for operating the component normally; and
generating expected-configuration information describing the component for operating the design target, the peripheral configuration, and a relationship between the component and the peripheral configuration from basic architecture information including the component and the peripheral configuration included in a first analysis result output by the large language model device based on the first prompt information.
